(19) United States
(12) Patent Application Publication
(10) Pub. No.: US 2015/0081321 A1
(43) Pub. Date: Mar. 19, 2015

(54) METHODS AND SYSTEMS OF PROVIDING PRESCRIPTION REMINDERS

(71) Applicant: MOBILE INSIGHTS, INC., Warrenville, IL (US)

(72) Inventor: Ajay Jain, Naperville, IL (US)

(73) Assignee: MOBILE INSIGHTS, INC., Warrenville, IL (US)

(21) Appl. No.: 14/270,939

(22) Filed: May 6, 2014

Related U.S. Application Data
(60) Provisional application No. 61/879,343, filed on Sep. 18, 2013.

(51) Int. Cl. G06F 19/00

(52) U.S. Cl. CPC G06F 19/3456
USPC 705/2

(57) ABSTRACT

Methods, apparatuses and one or more non-transitory computer-readable media are disclosed. In some examples, the methods include receiving a user's prescription information, then executing language processing logic stored at least one non-transitory computer-readable medium to generate structured prescription data from the user's prescription information, and then subsequently executing language generation logic stored on at least one non-transitory computer-readable medium to reconstitute the structured prescription data into a suggested natural language prescription instruction, and then transmitting a prescription reminder that includes the suggested natural language prescription instruction. In some examples, apparatuses and one or more non-transitory computer-readable media include components capable of performing similar steps and methods.

### PRIORITY CLAIM

This application claims priority from provisional application No. 61/879,343, filed on Sep. 18, 2013, where this provisional application is incorporated by reference in its entirety into the present application as if fully set forth herein.

### FIELD OF THE INVENTION

Certain aspects of the invention relate to use of prescription information to create prescription reminders. In particular, certain aspects of the invention relate to methods, apparatuses and one or more non-transitory computer-readable media for analyzing prescription information and instructions, and for creating such reminders. In certain examples, the methods, apparatuses and one or more non-transitory computer-readable media may relate to receiving a user's prescription information, such as a health-care provider supplied administration instructions, executing language processing logic to generate structured prescription data from the user's prescription information, executing language generation logic to reconstitute the structured prescription data into a suggested natural language prescription instruction, and transmitting a prescription reminder including the suggested natural language prescription instruction.

### BACKGROUND

Patients and other healthcare customers often forget or otherwise have trouble adhering to suggested or required medication/prescription regimens. These failures can cause or exacerbate current health problems, or prevent current health problems from being properly resolved. In addition to the avoidable pain, suffering, and/or other health problems experienced by the user, failure to adhere to prescription requirements generates large amounts of otherwise avoidable healthcare costs, on the level of more than an estimated one hundred and ninety billion dollars annually.

While systems for encouraging prescription adherence exist, these often require the user to directly fill out various data fields, and often require the user fill out tens of fields before the systems provide the user with reminders. These interfaces are time-consuming and difficult to use, and may require the user enter information that is not apparent or known to them, such as information that would typically only be known by a health-care professional. These problems are exacerbated because the prescription instructions and/or related materials often use specialized language, abbreviations, and/or structure that make them difficult to properly interpret by a layman. Thus, current systems may not allow a user to generate a proper reminder at all, require such a time investment that eliminates the convenience of the reminder system entirely, or inherently risk that a reminder that is based on and/or conveys incorrect information is created.

To alleviate these possible inefficiencies, it may be desirable to provide systems, methods, apparatuses, and non-transitory computer-readable media that allow a convenient and automatic reminder system that can readily provide easily understood prescription instructions based on the supplied prescription information.

### SUMMARY

This Summary provides an introduction to some general concepts relating to this invention in a simplified form that are further described below in the Detailed Description. This Summary is not intended to identify key features or essential features of the invention.

In accordance with one exemplary aspect of the invention, a method is provided. In some examples, the method automatically creates reminders for prescriptions after extracting knowledge from unstructured data in a supplied prescription instruction. In various examples, the method may comprise receiving a user's prescription information, executing language processing logic stored at least one non-transitory computer-readable medium to generate structured prescription data from the user's prescription information, then executing language generation logic stored on at least one non-transitory computer-readable medium to reconstitute the structured prescription data into a suggested natural language prescription instruction, and subsequently transmitting a prescription reminder, wherein the prescription reminder includes the suggested natural language prescription instruction.

In some examples, the executing language processing logic step includes parsing the user's prescription information for unstructured data that corresponds to one or more categories of structured prescription data, and then, responsive to determining the prescription information includes unstructured data corresponding to one or more categories of structured prescription data, assigning a category attribute to the corresponding one or more categories, wherein the category attribute is based on the corresponding unstructured data and wherein the structured prescription data comprises the assigned category attribute. In certain examples the method further comprises, responsive to determining the prescription information does not include unstructured data corresponding to any remaining categories of structured prescription data, assigning an absence attribute to the remaining categories.

In certain examples, the one or more categories of structured prescription data include a dosage category, a frequency value category, a frequency unit category, a strength value category, a strength unit category, a duration category, a form information category, a route of administration category, an administration instruction category, a food administration category, an administration time category, a medication information category, a symptom information category, a disease/disorder information category, an anatomical site information category, a dosage warning category, or a combination thereof. In various examples the method further includes receiving user compliance data after transmitting the prescription reminder and determining, based on the compliance data, the number of doses remaining for the user before their prescription runs out.

In some embodiments, the method includes social sharing steps and capabilities to share adherence data with other entities. In various examples, the method includes receiving user compliance data after transmitting the prescription reminder and transmitting the user compliance data to one or more social contacts of the user, one or more users taking identical or related prescriptions, the user's employer, the user's health insurance company, the user's medical provider, or a combination thereof.

In certain examples the method includes elements of gamification to encourage a user to adhere to the prescribed regimen. In various examples the method further includes comparing the user compliance data to one or more compliance standards, compliance data for one or more users taking identical or related prescriptions, or a combination thereof, assigning a compliance rank based on the comparison and providing the user with a reward based on their compliance rank.

In certain examples, the method may utilize an interface to collect provider supplied prescription administration instructions. In various embodiments of the method, the user's prescription information is received from the user, a pharmacy, the user's health insurance company, the user's medical provider, an external data source, or a combination thereof. In some examples, the user's prescription information generated by manual text entry, speech recordation and/or analysis, image and/or barcode scanning, or a combination thereof.

In certain examples, the method includes calculating a confidence score based on the relationship between the unstructured data and the corresponding assigned category attributes, the absence attributes, or a combination thereof. In various embodiments, the prescription reminder is transmitted to the user, one or more third parties previously identified by the user, one or more medical professionals, one or more medical devices, or a combination thereof. In some examples, the reminders are sent to a mobile device, and/or a cloud-based end point.

In various embodiments, the method including communicating or interface with pharmacy systems allow replenishment of prescriptions. In some examples, the method includes determining whether the number of remaining doses is below a predetermined threshold and subsequently, responsive to determining the number of remaining doses is below the predetermined threshold, transmitting a refill order to a prescription provider.

In accordance with another exemplary aspect of the invention, an apparatus is provided. In some examples the apparatus performs some or all of the steps described in the examples of the method found in this disclosure, and/or may otherwise include any of the features or components described in reference to the method examples of this disclosure. In certain embodiments, the apparatus includes at least one processor and at least one non-transitory computer-readable medium having stored therein computer executable instructions. In some examples, when the instructions are executed by the at least one processor, they cause the apparatus to receive a user's prescription information, execute language processing logic stored on the least one non-transitory computer-readable medium to generate structured prescription data from the user's prescription information, then execute language generation logic stored on the least one non-transitory computer-readable medium to reconstitute the structured prescription data into a suggested natural language prescription instruction and subsequently transmit a prescription reminder, wherein the prescription reminder includes the suggested natural language prescription instruction.

In certain examples, the computer executable instructions further cause the apparatus, when the language processing logic is executed, to parse the user's prescription information for unstructured data that corresponds to one or more categories of structured prescription data, and, responsive to determining the prescription information includes unstructured data corresponding to one or more categories of structured prescription data, assign a category attribute to the corresponding one or more categories, wherein the category attribute is based on the corresponding unstructured data and wherein the structured prescription data comprises the assigned category attribute. In certain examples, the computer executable instructions further cause the apparatus, when the language processing logic is executed, to, responsive to determining the prescription information does not include unstructured data corresponding to any remaining categories of structured prescription data, assign an absence attribute to the remaining categories. In some examples, the one or more categories of structured prescription data include a dosage category, a frequency value category, a frequency unit category, a strength value category, a strength unit category, a duration category, a form information category, a route of administration category, an administration instruction category, a food administration category, an administration time category, a medication information category, a symptom information category, a disease/disorder information category, an anatomical site information category, a dosage warning category, or a combination thereof.

In various embodiments of the apparatus, the computer executable instructions further cause the apparatus to receive user compliance data after transmitting the prescription reminder; and transmit the user compliance data to one or more social contacts of the user, one or more users taking identical or related prescriptions, the user's employer, the user's health insurance company, the user's medical provider, or a combination thereof. In some examples of the apparatus, the computer executable instructions further cause the apparatus to compare the user compliance data to one or more compliance standards, compliance data for one or more users taking identical or related prescriptions, or a combination thereof, assign a compliance rank based on the comparison, and provide the user with a reward based on their compliance rank.

In some examples of the apparatus, the computer executable instructions further cause the apparatus to receive user compliance data after transmitting the prescription reminder and determine, based on the user compliance data, the number of doses remaining for the user before their prescription runs out.

In accordance with another exemplary aspect of the invention, one or more non-transitory computer-readable media are provided. In some examples, the one or more media store computer-readable instructions that, when executed by at least one computer, cause the at least one computer to receive a user's prescription information, execute language processing logic stored on the least one non-transitory computer-readable medium to generate structured prescription data from the user's prescription information, then execute language generation logic stored on the least one non-transitory computer-readable medium to reconstitute the structured prescription data into a suggested natural language prescription instruction, and then transmit a prescription reminder, wherein the prescription reminder includes the suggested natural language prescription instruction. In some examples, the one or more non-transitory computer-readable media contain instructions causing at least one computer to perform some or all of the method steps described in the examples of the method found in this disclosure, and/or may otherwise include any of the features or components described in reference to the method and/or apparatus examples of this disclosure.

In some examples, the computer-readable instructions further cause the at least one computer to parse the user's prescription information for unstructured data that corresponds to one or more categories of structured prescription data, and then, responsive to determining the prescription information includes unstructured data corresponding to one or more categories of structured prescription data, assign a category attribute to the corresponding one or more categories, wherein the category attribute is based on the corresponding unstructured data and wherein the structured prescription data comprises the assigned category attribute. In certain examples, the computer-readable instructions then cause the at least one computer, responsive to determining the prescription information does not include unstructured data corresponding to any remaining categories of structured prescription data, assign an absence attribute to the remaining categories. In certain examples the one or more categories of structured prescription data include a dosage category, a frequency value category, a frequency unit category, a strength value category, a strength unit category, a duration category, a form information category, a route of administration category, an administration instruction category, a food administration category, an administration time category, a medication information category, a symptom information category, a disease/disorder information category, an anatomical site information category, a dosage warning category, or a combination thereof.

In certain embodiments, the computer-readable instructions cause the at least one computer to receive user compliance data after transmitting the prescription reminder, and determine, based on the user compliance data, the number of doses remaining for the user before their prescription runs out, then determine whether the number of remaining doses is below a predetermined threshold, and, responsive to determining the number of remaining doses is below the predetermined threshold, transmit a refill order to a prescription provider.

In various examples, the computer-readable instructions further cause the at least one computer to receive user compliance data after transmitting the prescription reminder, and transmit the user compliance data to one or more social contacts of the user, one or more users taking identical or related prescriptions, the user's employer, the user's health insurance company, the user's medical provider, or a combination thereof.

In other examples, the computer is a server and the one or more non-transitory computer-readable media store one or more rules or algorithms that are accessed by the computer when the processing logic is executed, and the computer-readable instructions further cause the at least one computer to, responsive to receiving a request from an external client, transmit a list of the one or more rules or algorithms, receive one or more modified rules or algorithms from the external client, and responsive to receiving the one or more modified rules or algorithms, save the one or more modified rules or algorithms on the one or more non-transitory computer-readable media for future access by the computer during executing of the processing logic.

It is an object of some examples of the methods, apparatuses, and non-transitory computer media to utilize information from provider supplied administration instructions to create reminders and replenish prescriptions. In other examples, it is an object to provide features allowing a user to easily and quickly provide such instructions, and in some examples provide the instructions in a single action. In other examples, it is an object to extract semantic information from the instructions and generate human readable text. In other examples, it is an object with to subsequently interface with pharmacy systems to automate refilling of prescriptions. In other examples, it is an object to incorporate elements of gamification to encourage end users to adhere to the prescription instructions. In other examples, it is an object to allow users to create a list of other parties to share compliance data related to the user's adherence to their prescription regimen.

### BRIEF DESCRIPTION OF THE DRAWINGS

Exemplary embodiments of the disclosure will now be described by way of example only and with reference to the accompanying drawings, in which:

FIG. 1 illustrates a schematic diagram of a general-purpose digital computing environment in which certain aspects of the present disclosure may be implemented.

FIG. 2 an illustrative block diagram of client end point computing devices and servers that may be used to implement the processes and functions of certain embodiments of the present disclosure.

FIG. 3 is a flowchart of an exemplary method in accordance with one or more embodiments.

FIG. 4 is an illustrative diagram of devices and end points that that may be used to implement the processes and functions of certain embodiments of the present disclosure.

FIG. 5 is an illustrative diagram of devices and end points that that may be used to implement the processes and functions of certain embodiments of the present disclosure.

### DETAILED DESCRIPTION OF EMBODIMENTS

The embodiments, apparatuses and methods described herein provide methods, apparatuses, and one or more non-transitory computer-readable media. In the following description of various examples of prescription reminder systems and methods of the this disclosure, reference is made to the accompanying drawings, which form a part hereof, and in which are shown by way of illustration various example structures and environments in which aspects of the invention may be practiced. It is to be understood that other structures and environments may be utilized and that structural and functional modifications may be made from the specifically described structures and methods without departing from the scope of the present invention. It is to be further understood that the methods, apparatuses and non-transitory media capable of other embodiments and of being practiced and carried out in various ways. Also, it is to be understood that the phraseology and terminology employed herein are for the purpose of the description and should not be regarded as limiting.

The embodiments, apparatuses and methods described herein provide for the analyzation and reconstitution of prescription information, for example provider supplied prescription administration information, and the generation of prescription reminders based on the same information. These and other aspects, features and advantages of the invention or of certain embodiments of the invention will be further understood by those skilled in the art from the following description of exemplary embodiments.

Various aspects described herein may be embodied as a method, a data processing system, and/or a computer program product. Accordingly, those aspects may take the form of an entirely hardware embodiment, an entirely software embodiment and/or an embodiment combining software and hardware aspects. Furthermore, such aspects may take the form of a computer program product stored by one or more non-transitory computer-readable storage media having computer-readable program code, or instructions, embodied in or on the storage media. The term “computer-readable medium” or “computer-readable storage medium” as used herein includes not only a single medium or single type of medium, but also a combination of one or more media and/or types of media. Such a non-transitory computer-readable medium may store computer-readable instructions (e.g., software) and/or computer-readable data (i.e., information that may or may not be executable). Any suitable computer readable media may be utilized, including various types of tangible and/or non-transitory computer readable storage media such as hard disks, CD-ROMs, optical storage devices, magnetic storage devices, and/or any combination thereof.

Aspects of the method steps disclosed herein may be executed on one or more processors on a computing device 101. Such processors may execute computer-executable instructions stored on non-transitory computer-readable media. The disclosure may also be practiced in distributed computing environments where tasks are performed by remote processing devices that are linked through a communications network. In a distributed computing environment, program modules may be located in both local and remote computer storage media including memory storage devices.

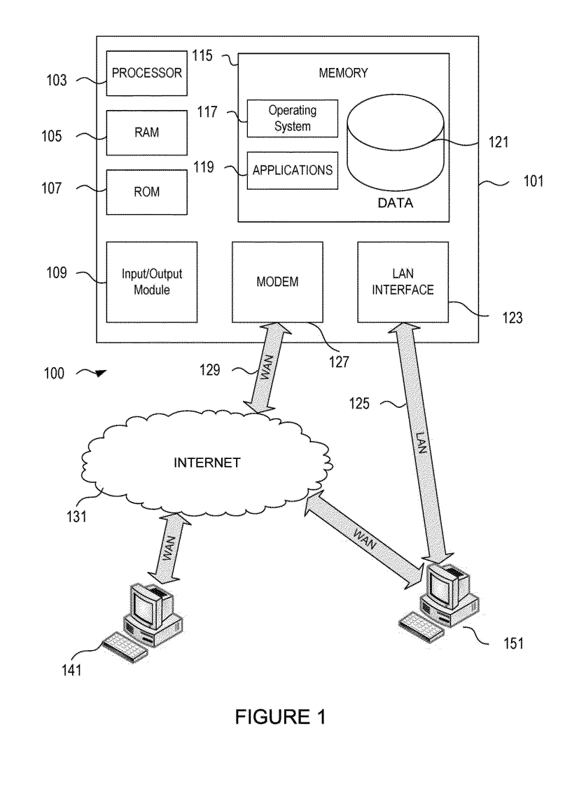

FIG. 1 illustrates a block diagram of a generic computing device 101 (e.g., a computer server) that may be used according to an illustrative embodiment of the disclosure. The computing device 101 may have a processor 103 for controlling overall operation of the server and its associated components, including RAM 105, ROM 107, input/output module 109, and memory 115.

Software may be stored within memory 115 and/or storage to provide instructions to processor 103 for enabling computing device 101 to perform various functions. For example, memory 115 may store software used by the computing device 101, such as an operating system 117, application programs 119, and an associated database 121. Alternatively, some or all of server 101 computer executable instructions may be embodied in hardware or firmware (not shown).

The disclosure is operational with numerous other general purpose or special purpose computing system environments or configurations. Examples of well-known computing systems, environments, and/or configurations that may be suitable for use with the disclosure include, but are not limited to, personal computers, server computers, hand-held or laptop devices, smartphones, mobile devices, multiprocessor systems, microprocessor-based systems, set top boxes, programmable consumer electronics, network PCs, minicomputers, mainframe computers, distributed computing environments that include any of the above systems or devices, and the like.

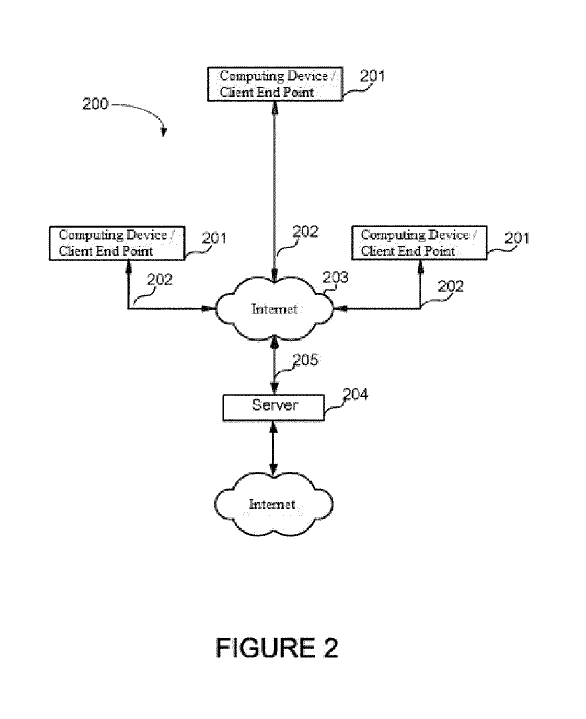

Referring to FIG. 2, an illustrative system 200 for implementing methods according to the present disclosure is shown. As illustrated, system 200 may include one or more client end points 201. The client end points may be a client computing device, such as a mobile phone. Client end points 201 may be local or remote, and are connected by one or more communications links 202 to a computer network 203, in this example the Internet, that is linked via communications links 205 to server 204. In system 200, server 204 may be any suitable server, processor, computer, or data processing device, or combination of the same.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, and the like.

The steps described below and that are in the example Figures may be implemented by one or more of the components described above and/or in FIGS. 1 and 2, and/or other components, including other computing devices.

In accordance with one exemplary aspect of the invention, a method is provided. In some examples, the method automatically creates reminders for prescriptions by extracting knowledge from unstructured data in prescription instructions, such as a prescription administration instruction provided by a healthcare provider. In various examples, the method may comprise receiving a user's prescription information. In some embodiments, a user may generate or enter the prescription information, such as a provider supplied administration instructions, by manual text entry, such as through a keypad or keyboard of a computing device, including but not limited to a mobile phone or smartphone. In various examples, the user may generate or enter the prescription administration instructions by speaking them aloud to a computing device, which then records and/or analyzes the speech and converts the audio to textual information. In some examples, the user takes a picture or otherwise scans a label of the prescription medicine and the instructions are determined via optical character recognition or similar processes designed to extract the textual information from the image. In various examples, a user scans a bar code on their prescription to enter the data, including but not limited to one or two dimensional bar codes such as QR codes. In some examples, an external data source or a message from an external system provides the prescription information. For example, prescription information may be sent from the user's healthcare facility, physician, insurance company, pharmacy, employer (or another entity that may provide the user with health insurance, such as an educational institution), a pharmaceutical drug company, a combination thereof, and the like.

In some examples, the method may utilize an interface, for example a GUI interface on a website or smartphone that prompts the user to provide or generate the prescription information, for example by asking the user to scan a bar code or read the provided instructions aloud into an input device such as a microphone. In some embodiments, the method may comprise verifying the instructions. For example, a computing device may display the entered or generated prescription instructions to the user and ask them to verify the displayed instructions are equivalent to those provided by the provider, e.g. the user's pharmacy. In various examples, the prescription information is sent to a cloud-computing platform or server. In some examples, the user also sends or generates a drug code corresponding to the medication utilized in the prescription. In certain examples, the user sends a request for a reminder from an end point such as a mobile device or their personal computing device to initiate the method. The user may then receive a message on the same device requesting the user to provide the prescription information. In some embodiments, a collection interface allows the direct collection of the prescription information from the user's computing device or some other external source, such as a healthcare provider database and/or a pharmacy database. Regardless of the collection method, the prescription information may come from the user, a pharmacy, the user's health insurance company, the user's medical provider, an external data source, or a combination thereof.

In some examples, the method may utilize natural language processing (“NLP”) and/or natural language generation (“NLG”) frameworks to analyze the prescription information and generate a suggested medication reminder. In various examples, the method includes executing language processing logic stored at least one non-transitory computer-readable medium to generate structured prescription data from the user's prescription information. In certain examples, the logic is stored and executed on a server.

In certain examples, the executing language processing logic step includes parsing the user's prescription information for unstructured data that corresponds to one or more categories of structured prescription data. For example, many prescription instructions as supplied by a healthcare provider utilize abbreviations, Latin terms, medical terminology that is not apparent to a layperson, or may not explicitly provide certain types of data at all, for example because certain assumptions are made on the part of the provider. The components of such instructions are referred to herein as “unstructured data.” In such a form, a user often cannot provide the information typically required by current prescription reminder systems, or can only do so with difficulty and substantial time investment. As a representative example, an instruction of “1 p.o. p.r.n. 1× daily” may provide, in an unstructured form, a dosage, i.e. one pill or tablet as provided (“1”), a frequency value, i.e. once (“1×”), a frequency unit, i.e. per day (“daily”), and an administration instruction, i.e. as required or as needed (in this example, “p.r.n.” stands for pro re nata, the Latin phrase for “as required”), and a route of administration, i.e. by mouth/ingestion (in this example, “p.o.” stands for per os, the Latin phrase for “by way of mouth”).

Thus, the prescription information including the provider supplied instructions may include unstructured data that corresponds to various categories of structured data, for example, categories for dosage, frequency value, frequency unit, strength value, strength unit, duration, form information, route of administration, administration instruction, food administration, administration time, medication information, symptom information, disease/disorder information, anatomical site information, dosage warning information, and the like.

In various examples, the method may utilize a plurality of rules and/or heuristic algorithms stored on a computer readable medium to parse the unstructured data and convert it to structured data. In certain embodiments, the method applies rules and/or algorithms to identify, categorize, convert, and/or structure the unstructured data. For example, the method may include parsing the unstructured data to identify each unit of unstructured data, for example by identifying each block of text that is separated from other text by a space and/or punctuation. Other identification rules may be used to parse the unstructured data for commonly used terms or characters to identify units of unstructured data. The method may include joining multiple identified units of unstructured data, such as one or more adjacent units, and subsequently analyzing these joined units to determine if they correspond to one category of unstructured data (e.g. when multiple words are used to provide information for one category). For example, identification rules may use vocabulary mapping and conversion, and/or identify possible lexical variants to identify one or more units of text that correspond to one or more structured data categories.

In certain examples, the method may include then comparing each unit of the unstructured data to a set of categorization rules, algorithms and/or a table of category identifiers stored on a computer readable medium to determine what, if any, category the unit of unstructured data corresponds to. The categorization rules, algorithms, and/or tables may utilize vocabulary mapping and conversion, and/or identify possible lexical variants. In certain examples, the categorization rules normalize and/or disambiguate unstructured data information.

In various examples, the received prescription information is normalized and/or disambiguated using pre-processing rules before the normalized and disambiguated information is then processed through the execution of language processing logic to generate the structured data. In some examples, the execution of normalization and disambiguation rules result in parsing the prescription information for duplicative information and removing the extraneous data. In certain examples, the rules may result in recognizing and correcting typographical errors. In various embodiments, the rules may result in recognizing partial information included in the prescription information and converting and/or supplementing the partial information to a more detailed and/or a different form. In certain examples, the normalization and disambiguating is subsumed in the steps of the language processing logic execution.

As representative examples of the application of category identification in the language processing, a rule and/or a mapping table may note “prn” or a similar variant such as “p.r.n.” or “PRN” corresponds to a food administration category, that “a.c.” (abbreviation standing for ante cibum, the Latin phrase for “before meals”) or terms such as “breakfast,” “food” “meal” and the like, correspond to a food administration category, and so on. In certain embodiments, after the instruction is parsed and one or more units of the unstructured data are identified, the units of unstructured data are categorized via rules, algorithms, and/or tables and the like, and are then annotated with a category token used to identify the relevant category of the parsed unstructured information during later processing.

In some examples, the identification of unstructured units and the categorization of unstructured units may be performed simultaneously, and in others the method may comprise identifying units of unstructured data, categorizing the unstructured units, and re-executing the identification rules, algorithms, and/or steps to re-identify units of any remaining unstructured data. For example, a typographical error in the term “p.r.n.” adding a space may result in identification of “p.” and “r.n.” as separate units that do not meet any categorization rules, but when the initial categorization fails the method may comprise joining remaining adjacent units of unstructured data to determine if, when joined, the joined unstructured unit may be categorized. In some examples, the joining is performed as an initial step or an additional step in the initial identification process (i.e. in this example both “p.” and “r.n.” and the combined term “p.r.n.” could be initially identified for subsequent categorization). As another representative example, related or complimentary terms may be joined together, for example the term “empty” near the term “stomach” may result in joining and ultimately categorizing these terms together in the food administration category.

In some examples, the executing language processing logic step may then include, responsive to determining the prescription information includes unstructured data corresponding to one or more categories of structured prescription data, assigning a category attribute to the corresponding one or more categories, wherein the category attribute is based on the corresponding unstructured data. For example, the method may comprise comparing each unit of categorized unstructured data to a table of assignment values stored on a computer readable medium to determine what category attribute to assign. The attribute assignment rules, algorithms, and/or tables may utilize vocabulary mapping and conversion, and/or identify possible lexical variants. For example, an attribute assignment rule or table may note “prn” corresponds to “as required” and assign “as required” as the attribute to the administration instruction category, or that “a.c.” corresponds to “before meals” and assign “before meals” as the attribute to the food administration category, and the like. As other representative examples, an attribute assignment rule or table may note that “h.s.” means “at bedtime,” “q3h” means “every three hours,” “q.i.d.” means “four times a day,” “p.o.” means “by mouth,” and so on, and assign the appropriate attribute to the appropriate structured data category. In certain examples, the attribute assignment rules normalize and/or disambiguate unstructured data information. Other rules or table may convert unstructured data into structured data corresponding to a symptoms category (e.g. pain, itching, rash, and the like), disease/disorder information category (e.g. asthma), anatomical site category (e.g. left eye, nostril, skin, mouth, and the like), dosage warning category (e.g. information conveying a maximum dosage, such whether a certain number of doses should not be exceeded per day), and the like.

In some examples, one set of rules, algorithms, and/or table(s) may be used to identify and/or annotate the structured data category that corresponds to a unit of unstructured data, and one or more subsequent set(s) of rules, algorithms, and/or table(s), such as a rule set or table for each corresponding structured data category, are then used to convert the unstructured data and assign a category attribute to the appropriate category. These and similar examples of the method examples thus extract knowledge and utilize semantic information from the instructions and convert it to a structured form that is then usable to generate natural language instructions.

In various embodiments, the identification of unstructured units, categorization of unstructured units, and the assignment of structured data may be performed simultaneously, or in turn for each unit of text in the prescription information. As one representative example, the term “prn” may be parsed from unstructured data, identified as information that corresponding to an administration instruction category, and subsequently converted to an administration instruction of “as required,” i.e. “as required” is assigned as the category attribute to the administration instruction category. Then, the same steps could be performed for the next unstructured unit and/or text instance in the prescription information provided by the healthcare provider.

In various examples, the method includes use of heuristic algorithms to infer one or more category attributes for one or more categories of structured data, and/or additional data points for later reconstitution into a natural language prescription reminder. In certain examples, the heuristic algorithms normalize and/or disambiguate unstructured data information, for example during the language processing step or afterward. In various examples, the method further comprises applying the heuristic algorithms to analyze any unstructured data that is not identified as corresponding to a structured data category, and/or any unstructured data in any categories where, e.g., the category assignment rules cannot assign a category attribute based on the unstructured data.

In various examples, the heuristic algorithms and rules are applied in a post-processing step after the execution of the language processing logic. In certain examples, the heuristic algorithms are used to convert unstructured data that includes, is similar to, and/or parallels text or other information that could be identified, categorized and/or used to assign a particular category attribute under the rules and/or table mechanisms previously described. In these examples, the unstructured data would be treated as if it was identical to or included the unstructured data content that appropriate the rule/table applied to. In various examples, one or more heuristic algorithms may be used to assign category attributes based on the category attributes in other structured data categories, and/or information from an external database, such as a pharmacy database.

As a representative example, when prescription information that contains information corresponding to the medication information, dosage and frequency categories, a heuristic algorithm may be used to assign a food administration attribute based on the already known category attributes. As another representative example, when prescription information includes unstructured data comprising the terms “breakfast,” “lunch” and “dinner,” or the plural term “meals,” a heuristic algorithm may be used assign a frequency category attribute of “three times per day.” In certain examples, the heuristic algorithms utilize information from a data repository to determine if assumptions may be made based on the available structured data category attribute information. In some embodiments, the data repository may comprise medical information, drug and pharmaceutical information, and commonly used prescription information. Often, a doctor or other healthcare professional will assume certain information will be filled in or otherwise provider for a patient that is not included in the provider supplied prescription information. In certain of these examples applying heuristic algorithms, the user is thus provided with this additional information that would otherwise not be part of the prescription reminder. In some examples, and as described in more detail below, a third party or healthcare provider can provide assumption rules for the heuristic algorithms or otherwise tailor what assumptions are made when certain categories of information are missing and/or incomplete.

In certain examples the method further comprises, responsive to determining the prescription information does not include unstructured data corresponding to any remaining categories of structured prescription data, assigning an absence attribute to the remaining categories.

In certain examples, the method includes calculating a confidence score based on the relationship between the unstructured data and the corresponding assigned category attributes, the absence attributes, or a combination thereof. In some embodiments the confidence score may be provided along with the prescription reminder. The confidence score may tally or otherwise reflect (through, e.g. a multiplier) the number of heuristic inferences and/or assumptions, the number of units of unstructured data that cannot be categorized and/or converted to an assigned category attribute, and/or the number of structured data categories that were assigned an absence attribute, and/or that one or more of any of these situations (e.g. there are two assumptions) or categories of situations (e.g. there is at least one assumption) exists. In some embodiments, the confidence score may reflect the type of heuristic inference and/or assumption, and adjust the confidence score more or less significantly based on the type of inference and/or assumption. As a representative example, a confidence score of 100% could reflect when no inferences or assumptions are made and all units of unstructured data are converted to a category attribute, while a score of 90% reflects that one unit of unstructured data was not converted to a category attribute, and a confidence score of 81% (via the application of another 0.9 multiplier) further reflects that one heuristic inference and/or assumption was made. In some examples, the confidence score is determined in the post-language processing step. In various examples, the confidence score is generated using one or more confidence heuristic algorithms and/or rules.

Thus, in examples of method the processing logic results in identifying all data in the unstructured data of the prescription information that corresponds to a structured data category, and then assigns a category attribute or attributes based on the semantic information in the unstructured data. These structured attributes may then be used to generate a natural language prescription reminder as described below.

In certain examples, the processing logic steps are implemented on a computer readable medium running code based on processing frameworks such as Universal Information Management Architecture (“UIMA”), Clinical Text Analysis and Knowledge Extraction System (“cTAKES”), and Rule-based Text Analysis (“RUTA”), all of the Apache Group, with additional algorithms, heuristics, and rules added thereto.

In some examples, the method then includes executing language generation logic stored on at least one non-transitory computer-readable medium to reconstitute the structured prescription data into a suggested natural language prescription instruction. In certain examples the method further comprises subsequently transmitting a prescription reminder. In various examples the prescription reminder includes the suggested natural language prescription instruction.

The suggested natural language prescription instruction may consist of or comprise easily understood, human readable text without the use of medical terms of art and the like. A plurality of language generation rules may be used to reconstitute the structured data category attribute into a natural language instruction. The plurality of language generation rules may also include rules for use of grammar, syntax and punctuation to construct sentences containing the reconstituted information. As one representative example, prescription information providing an instruction of “1 p.o. p.r.n. 1× daily” may ultimately result (through, e.g., pre-processing analysis, natural language processing, post-processing heuristic analysis, and then natural language generation) in a natural language reminder of “Take one pill daily, by mouth, as needed.” In some examples, the reminder may reflect or be based on the timing information provided in the prescription information. For example, an identical reminder may be sent twice daily that recites “Take one pill, with food, as soon as possible.” In other examples, a single reminder may be sent per day describing all the times a dose is needed. In certain examples, reminders may suggest a time range (e.g. within 15 minutes, 30 minutes, and the like) or may suggest taking a pill with the next meal, whenever that is. In certain examples, a warning time may be set by the user or another party, and a warning may be sent before the actual reminder. For example, a warning may be transmitted to a user stating “In thirty minutes, you will need to take [medication name], with food,” so that the user may prepare as needed for whatever the specific needs for the medication are.

In various examples, the suggested natural language prescription instruction includes the confidence score, or a natural language confidence indicator based on the confidence score, wherein the natural language confidence indicator may also be generated by the execution of language generation logic. In certain examples, the reminder may comprise the structured information, for example in a “category:category attribute” text string, e.g. “Frequency: Twice daily” so that the user has the prescription information in a structured rather than an unstructured format, even if, in certain examples, it is not in the form of a natural language reminder. Example reminders with the structured information may also comprise a confidence score. In certain examples, the reminder or structured information is sent in extensible markup language format, while in others in hypertext markup language format.

In some embodiments, the reminder is transmitted to a client end-point, such as a user's mobile device, a user's email account, a user's email calendar, a user's cloud-based calendar or other cloud-based end point, or a combination thereof. In various embodiments, the prescription reminder is transmitted to one or more third parties, including third parties previously identified by the user or a health care provider, for example when the user or provider provides the initial prescription information. In certain examples, the prescription reminder is sent to a third party's mobile device, email, calendar, or a combination thereof. In some examples, a third party receiving the reminder is one or more medical professionals (including but not limited to a physician, nurse, pharmacist, home care assistant, or related personnel, such as a medical professional tasked with providing or administering medication to the end user), one or more medical devices (such as a device capable of automatically administering medicine when receiving the reminder or at a time identified by the reminder), or a combination thereof. In some embodiments, both the user and one or more third parties receive the reminders.

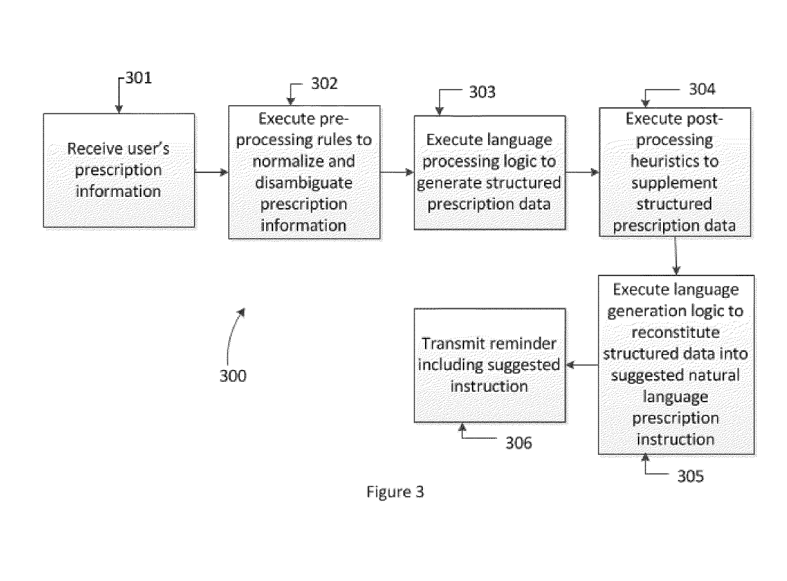

FIG. 3 provides a flowchart illustrating the steps of an exemplary embodiment 300 of the method. In step 301, the user's prescription information is received. In this and other exemplary embodiments, in pre-processing step 302 rules normalize and disambiguate the incoming prescription information, and then in step 303 the language processing logic is executed to generate structured prescription data based on the normalized and disambiguated information. In step 304, post-processing rules and/or inferences heuristics are used to supplement the generated structured data. Then, in step 305, language generation logic is executed to reconstitute the structured data into a suggested natural language prescription instruction. Finally, in step 306 a reminder including the suggested natural language prescription instruction is transmitted. In some embodiments, all of these steps are performed on an application server.

In some embodiments, the method includes social sharing steps and capabilities or a social sharing engine to share adherence data with other entities. In various examples, the method includes receiving user compliance data after transmitting the prescription reminder. For example, the reminder may include an option for a user to indicate they consumed the medication when prompted by the reminder, such as by presenting a compliance button or a compliance field where a user can then enter data via text/speech/the like on a mobile device as part of the reminder, or automatically displaying a compliance button after the user closes the reminder. In various examples, the method then includes transmitting the user compliance data to one or more social contacts or clients. In certain embodiments, the compliance data is transmitted to one or more family members, friends or social networks of the user, one or more users taking identical or related prescriptions (for example, by supplying compliance data to a group containing users taking similar medications, where the users may be anonymous or identified by abbreviations or pseudonyms), the user's employer, the user's health insurance company, the user's medical provider, other cloud-based services, or a combination thereof. In certain embodiments, the information may be shared using email, text messages (e.g. “SMS”), push notifications, automated phone calls, automated edits to cloud-base documents and/or calendars, and the like.

In certain examples the method includes elements of gamification or a gamification engine to encourage a user to adhere to the prescribed regimen. In various examples the method further includes comparing the user compliance data to one or more compliance standards, such as a standard set by a medical authority, the user's healthcare provider, or another third party. In some examples, the user's compliance data may be compared to one or more users taking identical or related prescriptions. In various examples, the method may include, assigning a compliance rank based on the comparison (to the standard, other users, and the like), and then providing the user with a reward based on their compliance rank. For example, if a user exceeds a compliance standard set by their healthcare provider or insurance company, they may receive a reward such as a discount on subsequent costs or services, or a partial refund on the medication that was the subject of the prescription. In another example, if the user's compliance rank exceeds the rank of a certain amount of other users, for example is in the top half of all users taking the same medication, the user may receive a reward.

In still other examples, the user may receive a reward if complying a certain number of times in a row, for example when a third party such as a pharmacy sets a recurrence threshold that is met by the user (e.g. when every dose of medication is taken for a week, for ten straight days, and the like). The rewards may be from the user's healthcare provider, employer, insurance company, physician, or other third party entity, or such an entity could sponsor a reward (such as a gift card or other non-medical and non-pharmaceutical commodity). In certain examples, the rewards may be abstract, such as a badge, a position on a leader board, and the like. Anything that may lead to a positive change in the user's medication adherence behavior may be used as a reward. In this manner, examples of the method provide gamification elements to encourage adherence when reminding the user of their prescription instructions using natural language.

In various examples the method includes receiving user compliance data after transmitting the prescription reminder and determining, based on the compliance data, the number of doses remaining for the user before their prescription runs out. In some examples, each instance of compliance is saved on a computer readable medium and, subsequent to being saved, the total amount of compliant acts is tabulated and compared to a category attribute for a total dosage category. In some examples, the total dosage category attribute is determined using the category attributes for the duration, dose, and/or frequency categories, including a calculation based on one or more of these factors. As a representative example, an assigned frequency attribute of “two times a day” or a similar attribute, and a duration attribute of “thirty days” would be converted via a total dosage algorithm to a total dosage of 60 doses. In certain examples, the total dosage category is provided as part of the prescription information in the provider supplied instructions (e.g. there is unstructured data identifying that a total of thirty doses were included with the prescription).

In various examples, the number of remaining doses is then transmitted to the user, or at certain increments is transmitted to the user (for example when ten doses remain, five doses remain, three doses remain, and the like). In other embodiments, a refill reminder is sent to the user when a certain number of doses remain, or when a certain time period will be covered by the remaining doses (i.e. a weeks' worth of medication remains, or three days' worth, and the like). In various examples, the refill reminder may be sent at a variable time, for example prior to the weekend preceding the week where the user will otherwise run out of medication. In certain of these examples, the method may keep a user apprised of when the prescription needs to be refilled without relying on assumptions of perfect compliance, which will be flawed if a user misses one or more administrations that would otherwise be assumed in a simple calculation based of the date of the prescription. In certain examples, the refill reminder is sent, or the prescription is automatically refilled, based on the number of days that have elapsed since the creation of the reminder or since the prescription was filled.

In certain examples, the user may then review the reminder and provide feedback. For example, the user may be provided the option to select whether the reminder is understandable, complete, and the like, or difficult to comprehend, provides contradictory information, is clearly missing information, and so on. In some embodiments, if the user provides feedback, any heuristic algorithms used to make inferences or assumptions may be discarded, altered, or saved depending on the type of feedback. For example, if a user indicates the frequency information is wrong and a heuristic algorithm was used to make an inference regarding frequency, a rule may be saved to ensure that algorithm is no longer used at all, or is no longer used when similar unstructured information is seen in the future.

In various embodiments, the method includes communicating or interfacing with one or more pharmacy systems to allow replenishment of prescriptions. In some examples, the method includes determining whether the number of remaining doses is below a predetermined threshold, including as described above, and, responsive to determining the number of remaining doses is below the predetermined threshold, subsequently transmitting a refill order to a prescription provider. In some embodiments, the pharmacy or the user's healthcare provider set the threshold, while in others a user may set the threshold based on their preferences. In various examples, the refill order is transmitted automatically when the threshold is met or exceeded, while in others the user may be prompted and asked if they would like the prescription to automatically be refilled, and/or asked if they would like to call a pharmacy and provided with the option to immediately do so, or to do so at a later time. In various examples, the method includes sending a refill reminder to the user, for example if the user declines to immediately call the pharmacy or otherwise place an order (e.g. online or thought a pharmacy mobile phone application). In certain embodiments, the user may provide preferred pharmacy information for all or some refills, and in other examples the refill order may automatically go to the pharmacy that filled the original order, or the nearest available pharmacy.

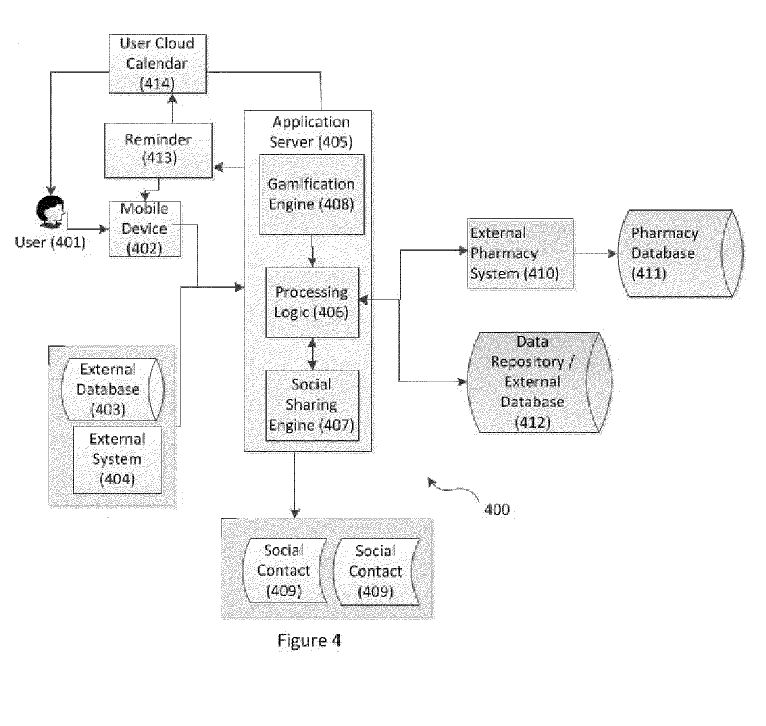

FIG. 4 provides an exemplary diagram of an embodiment 400. In this exemplary embodiment, a user 401 may use their mobile device 402 to send prescription information (with text, speech, image, and the like) to an application server 405. Alternatively, and external database and/or external system 404 may send the prescription information to the application server 405. In this example, the application server 405 comprises processing logic 406, a social sharing engine 407, and a gamification engine 408. The social sharing engine 407 may comprise instructions that, when executed, cause the application server to request and/or receive user compliance data and send the compliance data to one or more social contacts 409 of the user 401. The gamification engine 408 may comprise instructions that, when executed, cause the application server to request and/or receive user compliance data and transmit a reward to the user, or transmit a notification that the user will receive a reward (e.g. a tangible item to be delivered later). In certain embodiments, the application server 405 and/or the processing logic 406 interface with an external data repository and/or an external pharmacy system, for example to obtain additional information used in the processing or to automatically refill a user's prescription.

In some embodiments, the method includes utilizing an external interface, for example an interface with a pharmacy, insurance company, or healthcare provider (referred to hereafter as an “external client”) of a system of such an entity. The external client may utilize the interface to view, create, and/or edit some or all of the rules, algorithms, and/or tables utilized in the processing logic and/or generation logic. In some examples, the external client sends a request to a server over a computer network to access the external interface. The various examples, responsive to receiving a request from the external client, the server then transmits a list of rules, algorithms, and/or tables for a particular user, a particular group of users, or all users, where the external client request may identify the particular user or particular group of users. The external client may then create or edit one or more rules. For example, the external client may create a rule to allow identification, categorization, and/or an attribute assignment for a particular unit of unstructured data that is commonly used in the external client's unstructured prescription information supplied to a client. The certain examples, the external client edits already established rules to account for specific cases, for example to account for information specific to a particular user or group of users that is already present in the external client's database. In some embodiments, the external client then transmits the modified rules, algorithms, and/or tables back to the server, which stores them on one or more non-transitory media and uses them during the execution of processing logic for, e.g., users affiliated with the external client pharmacy.

In certain examples, the external interface allows viewing and access of rules for a pre-processing engine, i.e. rules used to structure, identify, and/or categorize unstructured data. In various examples, the external interface allows viewing and access of rules for a post-processing engine, i.e. rules to reconstitute the structured information and generate a structured reminder and/or a natural language reminder. In some embodiments, both the pre- and post-processing rules may be viewed, accessed, edited, and/or supplemented, and then utilized in the processing described herein.

In various examples, the external client may provide all the unstructured information needed to create a reminder for a user. In certain embodiments, the external client may provide the unstructured information to a server, where the server parses, normalizes, disambiguates, structures and/or converts the unstructured data as descried above. The server may then generate a suggested instruction and/or reminder and send it back to the external client, who then transmits it to the user, or the server may then relay the instruction and/or reminder, for example using contact information already known to the external client (e.g. a pharmacy that has a user's mobile phone number). In some examples, the server sends a request to the external client for user contact information. In some examples, the user information and prescription information may automatically be sent to the server immediately after the user initially fills a prescription. In certain examples, the server may send a reminder to an external client server that the user accesses with a smart phone application, where the reminder is automatically populated with the structured data and/or suggested natural language.

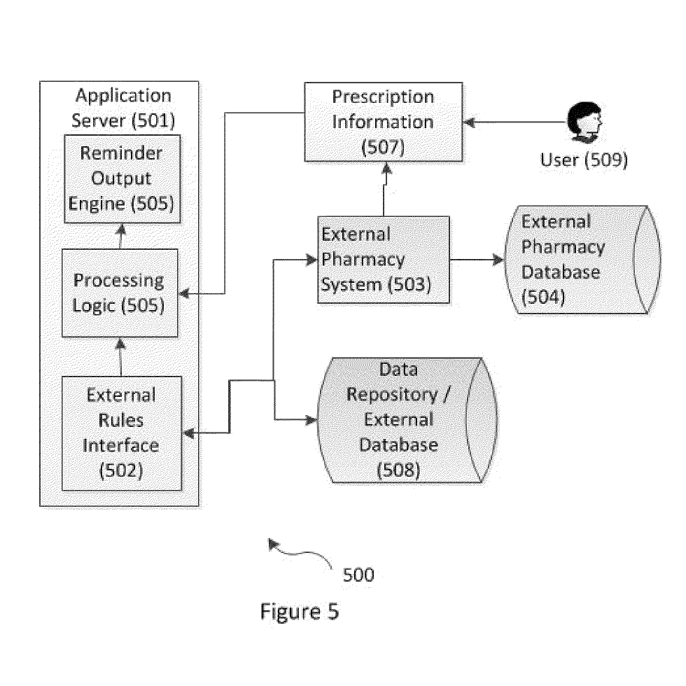

FIG. 5 provides an exemplary diagram of an embodiment 500 having an external interface. In this exemplary embodiment, the application server 501 has an external rules interface 502 that allows access by an external pharmacy system 503 to the processing logic 505 on application server 501. In some embodiments, the external pharmacy system may view, access, and/or edit rules utilized by the processing logic. Thus, in this example embodiment when the application server 501 receives prescription information 507 from a user 509 or via the external pharmacy system 503 (which in turn may include information from a database 504 of the same pharmacy, or other medical information on an external database 508), the external pharmacy may have its own set of specific rules used to process the information, which then determines the content provided to, e.g. the user via the reminder output engine 505.

In certain embodiments, both with and without an external interface, some or all of the processing and/or executing of logic may take place on a server accessible from the Internet, such as the server 204 of FIG. 2. The server, or a plurality of server, may provide a website with access to the processing functionality, including but not limited to a website that will accept prescription information, such as unstructured provider supplied administration instructions, and will then process the accepted information as described above. In some examples, the client end point, such as a mobile phone, may communicate with a third-party webserver that in turn may communicate with an application server on a different Internet domain. In certain examples, a smartphone application may access the server or the plurality of servers. In various embodiments, the application server may then access one or more databases and/or data repositories to retrieve pharmaceutical information, medical information, or user information. The application server, once the structured data is generated and/or the suggested natural language prescription instruction is generated, may then send the data and/or instruction directly to the client end point, or to the user via a third-party webserver. In certain embodiments, the plurality of servers include one or more of an application server containing language processing and generation logic stored at least one non-transitory computer-readable medium, a reminder server containing reminder generation and transmittal logic stored at least one non-transitory computer-readable medium, a gamification server, a social sharing server, or a combination thereof.

These descriptions of the method are merely exemplary. In certain embodiments, the method comprises additional combinations or substitutions of some or all of the steps and/or components described above. Moreover, additional and alternative suitable variations, steps, forms and components for method will be recognized by those skilled in the art given the benefit of this disclosure.

Other exemplary aspects of the invention relate to an apparatus. Any of the features discussed in the exemplary embodiments of the method may be features of embodiments of the apparatus, and vice versa. Moreover, any of the steps described in connection with the method examples may be performed by the apparatus, and vice versa.

In accordance with another exemplary aspect of the invention, an apparatus is provided. In some examples the apparatus performs some or all of the steps described in the examples of the method found in this disclosure, and/or may otherwise include any of the features or components described in reference to the method examples of this disclosure. In certain embodiments, the apparatus includes at least one processor and at least one non-transitory computer-readable medium having stored therein computer executable instructions. In some examples, when the instructions are executed by the at least one processor, they cause the apparatus to receive a user's prescription information, execute language processing logic stored on the least one non-transitory computer-readable medium to generate structured prescription data from the user's prescription information, then execute language generation logic stored on the least one non-transitory computer-readable medium to reconstitute the structured prescription data into a suggested natural language prescription instruction and subsequently transmit a prescription reminder, wherein the prescription reminder includes the suggested natural language prescription instruction.

In certain examples, the computer executable instructions further cause the apparatus, when the language processing logic is executed, to parse the user's prescription information for unstructured data that corresponds to one or more categories of structured prescription data, and, responsive to determining the prescription information includes unstructured data corresponding to one or more categories of structured prescription data, assign a category attribute to the corresponding one or more categories, wherein the category attribute is based on the corresponding unstructured data, and, responsive to determining the prescription information does not include unstructured data corresponding to any remaining categories of structured prescription data, assign an absence attribute to the remaining categories. In some examples, the one or more categories of structured prescription data include a dosage category, a frequency value category, a frequency unit category, a strength value category, a strength unit category, a duration category, a form information category, a route of administration category, an administration instruction category, a food administration category, an administration time category, a medication information category, a symptom information category, a disease/disorder information category, an anatomical site information category, a dosage warning category, or a combination thereof.

In various embodiments of the apparatus, the computer executable instructions further cause the apparatus to receive user compliance data after transmitting the prescription reminder; and transmit the user compliance data to one or more social contacts of the user, one or more users taking identical or related prescriptions, the user's employer, the user's health insurance company, the user's medical provider, or a combination thereof. In some examples of the apparatus, the computer executable instructions further cause the apparatus to compare the user compliance data to one or more compliance standards, compliance data for one or more users taking identical or related prescriptions, or a combination thereof, assign a compliance rank based on the comparison, and provide the user with a reward based on their compliance rank.

In some examples of the apparatus, the computer executable instructions further cause the apparatus to receive user compliance data after transmitting the prescription reminder and determine, based on the user compliance data, the number of doses remaining for the user before their prescription runs out. In certain examples, the apparatus is a server.

These descriptions of the apparatus are merely exemplary. In certain embodiments, the apparatus comprises additional combinations or substitutions of some or all of the components described above. Moreover, additional and alternative suitable variations, forms and components for apparatus, and steps capable of being performed by the apparatus, will be recognized by those skilled in the art given the benefit of this disclosure.

In accordance with another exemplary aspect of the invention, one or more non-transitory computer-readable media are provided. In some examples, the one or more media store computer-readable instructions that, when executed by at least one computer, cause the at least one computer to receive a user's prescription information, execute language processing logic stored on the least one non-transitory computer-readable medium to generate structured prescription data from the user's prescription information, then execute language generation logic stored on the least one non-transitory computer-readable medium to reconstitute the structured prescription data into a suggested natural language prescription instruction, and then transmit a prescription reminder, wherein the prescription reminder includes the suggested natural language prescription instruction. In some examples, the one or more non-transitory computer-readable media contain instructions causing at least one computer to perform some or all of the method steps described in the examples of the method found in this disclosure, and/or may otherwise include any of the features or components described in reference to the method and/or apparatus examples of this disclosure.

In some examples, computer-readable instructions further cause the at least one computer to parse the user's prescription information for unstructured data that corresponds to one or more categories of structured prescription data, and then, responsive to determining the prescription information includes unstructured data corresponding to one or more categories of structured prescription data, assign a category attribute to the corresponding one or more categories, wherein the category attribute is based on the corresponding unstructured data, and then, responsive to determining the prescription information does not include unstructured data corresponding to any remaining categories of structured prescription data, assign an absence attribute to the remaining categories. In certain examples the one or more categories of structured prescription data include a dosage category, a frequency value category, a frequency unit category, a strength value category, a strength unit category, a duration category, a form information category, a route of administration category, an administration instruction category, a food administration category, an administration time category, a medication information category, a symptom information category, a disease/disorder information category, an anatomical site information category, a dosage warning category, or a combination thereof.

In certain embodiments, the computer-readable instructions cause the at least one computer to receive user compliance data after transmitting the prescription reminder, and determine, based on the user compliance data, the number of doses remaining for the user before their prescription runs out, then determine whether the number of remaining doses is below a predetermined threshold, and, responsive to determining the number of remaining doses is below the predetermined threshold, transmit a refill order to a prescription provider.

In various examples, the computer-readable instructions further cause the at least one computer to receive user compliance data after transmitting the prescription reminder, and transmit the user compliance data to one or more social contacts of the user, one or more users taking identical or related prescriptions, the user's employer, the user's health insurance company, the user's medical provider, or a combination thereof.

These non-transitory computer-readable media descriptions are merely exemplary. In certain embodiments, the one or more media may include instructions causing at least one computer to perform additional combinations or substitutions of some or all of the steps described in this disclosure. Moreover, additional and alternative suitable variations, forms and components for the non-transitory computer-readable media will be recognized by those skilled in the art given the benefit of this disclosure, as well as additional and alternative suitable steps, and any feature or components described in reference to other aspects may be included in this aspect.

What is claimed is:

1. A method comprising:
receiving a user's prescription information;
executing language processing logic stored at least one non-transitory computer-readable medium to generate structured prescription data from the user's prescription information;
executing language generation logic stored on at least one non-transitory computer-readable medium to reconstitute the structured prescription data into a suggested natural language prescription instruction; and
transmitting a prescription reminder, wherein the prescription reminder includes the suggested natural language prescription instruction.

2. The method of claim 1, wherein the executing language processing logic step includes:
parsing the user's prescription information for unstructured data that corresponds to one or more categories of structured prescription data;
responsive to determining the prescription information includes unstructured data corresponding to one or more categories of structured prescription data, assigning a category attribute to the corresponding one or more categories, wherein the category attribute is based on the corresponding unstructured data, and wherein the structured prescription data comprises the assigned category attribute.

3. The method of claim 2, wherein the one or more categories of structured prescription data include a dosage category, a frequency value category, a frequency unit category, a strength value category, a strength unit category, a duration category, a form information category, a route of administration category, an administration instruction category, a food administration category, an administration time category, a medication information category, a symptom information category, a disease/disorder information category, an anatomical site information category, a dosage warning category, or a combination thereof.

4. The method of claim 1, further comprising:
receiving user compliance data after transmitting the prescription reminder; and
determining, based on the compliance data, the number of doses remaining for the user before their prescription runs out.

5. The method of claim 1, further comprising:
receiving user compliance data after transmitting the prescription reminder; and
transmitting the user compliance data to one or more social contacts of the user, one or more users taking identical or related prescriptions, the user's employer, the user's health insurance company, the user's medical provider, or a combination thereof.

6. The method of claim 5, further comprising:
comparing the user compliance data to one or more compliance standards, compliance data for one or more users taking identical or related prescriptions, or a combination thereof;
assigning a compliance rank based on the comparison; and
providing the user with a reward based on their compliance rank.

7. The method of claim 1, wherein the user's prescription information is received from the user, a pharmacy, the user's health insurance company, the user's medical provider, an external data source, or a combination thereof.

8. The method of claim 7, wherein the user's prescription information generated by manual text entry, speech recordation and/or analysis, image and/or barcode scanning, or a combination thereof.

9. The method of claim 2, wherein the executing language processing logic step includes, responsive to determining the prescription information does not include unstructured data corresponding to any remaining categories of structured prescription data, assigning an absence attribute to the remaining categories; and the method further comprising calculating a confidence score based on the relationship between the unstructured data and the corresponding assigned category attributes, the absence attributes, or a combination thereof.

10. The method of claim 1, wherein the prescription reminder is transmitted to the user, one or more third parties previously identified by the user, one or more medical professionals, one or more medical devices, or a combination thereof.

11. The method of claim 4, further comprising:
determining whether the number of remaining doses is below a predetermined threshold; and
responsive to determining the number of remaining doses is below the predetermined threshold, transmitting a refill order to a prescription provider.

12. An apparatus comprising:
at least one processor; and
at least one non-transitory computer-readable medium having stored therein computer executable instructions, that when executed by the at least one processor, cause the apparatus to:
receive a user's prescription information;
execute language processing logic stored on the least one non-transitory computer-readable medium to generate structured prescription data from the user's prescription information;
execute language generation logic stored on the least one non-transitory computer-readable medium to reconstitute the structured prescription data into a suggested natural language prescription instruction; and
transmit a prescription reminder, wherein the prescription reminder includes the suggested natural language prescription instruction.

13. The apparatus of claim 12, wherein the computer executable instructions further cause the apparatus, when the language processing logic is executed, to:
parse the user's prescription information for unstructured data that corresponds to one or more categories of structured prescription data;
responsive to determining the prescription information includes unstructured data corresponding to one or more categories of structured prescription data, assign a category attribute to the corresponding one or more categories, wherein the category attribute is based on the corresponding unstructured data, and wherein the structured prescription data comprises the assigned category attribute; and
wherein the one or more categories of structured prescription data include a dosage category, a frequency value category, a frequency unit category, a strength value category, a strength unit category, a duration category, a form information category, a route of administration category, an administration instruction category, a food administration category, an administration time category, a medication information category, a symptom information category, a disease/disorder information category, an anatomical site information category, a dosage warning category, or a combination thereof.

14. The apparatus of claim 12, wherein the computer executable instructions further cause the apparatus to:
receive user compliance data after transmitting the prescription reminder; and
transmit the user compliance data to one or more social contacts of the user, one or more users taking identical or related prescriptions, the user's employer, the user's health insurance company, the user's medical provider, or a combination thereof.

15. The apparatus of claim 14, wherein the computer executable instructions further cause the apparatus to:
compare the user compliance data to one or more compliance standards, compliance data for one or more users taking identical or related prescriptions, or a combination thereof;
assign a compliance rank based on the comparison; and
provide the user with a reward based on their compliance rank.

16. The apparatus of claim 12, wherein the computer executable instructions further cause the apparatus to:
receive user compliance data after transmitting the prescription reminder; and
determine, based on the user compliance data, the number of doses remaining for the user before their prescription runs out.

17. One or more non-transitory computer-readable media storing computer-readable instructions that, when executed by at least one computer, cause the at least one computer to:
receive a user's prescription information;
execute language processing logic stored on the least one non-transitory computer-readable medium to generate structured prescription data from the user's prescription information;
execute language generation logic stored on the least one non-transitory computer-readable medium to reconstitute the structured prescription data into a suggested natural language prescription instruction; and
transmit a prescription reminder, wherein the prescription reminder includes the suggested natural language prescription instruction.

18. The one or more non-transitory computer-readable media of claim 17, the computer-readable instructions further causing the at least one computer to:
parse the user's prescription information for unstructured data that corresponds to one or more categories of structured prescription data;
responsive to determining the prescription information includes unstructured data corresponding to one or more categories of structured prescription data, assign a category attribute to the corresponding one or more categories, wherein the category attribute is based on the corresponding unstructured data, and wherein the structured prescription data comprises the assigned category attribute; and
wherein the one or more categories of structured prescription data include a dosage category, a frequency value category, a frequency unit category, a strength value category, a strength unit category, a duration category, a form information category, a route of administration category, an administration instruction category, a food administration category, an administration time category, a medication information category, a symptom information category, a disease/disorder information category, an anatomical site information category, a dosage warning category, or a combination thereof.

19. The one or more non-transitory computer-readable media of claim 17, the computer-readable instructions further causing the at least one computer to:
receive user compliance data after transmitting the prescription reminder;
determine, based on the user compliance data, the number of doses remaining for the user before their prescription runs out;
determine whether the number of remaining doses is below a predetermined threshold; and
responsive to determining the number of remaining doses is below the predetermined threshold, transmit a refill order to a prescription provider.

20. The one or more non-transitory computer-readable media of claim 17, wherein the media store one or more rules or algorithms that are accessed by the computer when the processing logic is executed, and the computer-readable instructions further causing the at least one computer, wherein the at least one computer is at least one server, to:
responsive to receiving a request from an external client, transmit a list of the one or more rules or algorithms;
receive one or more modified rules or algorithms from the external client; and
responsive to receiving the one or more modified rules or algorithms, save the one or more modified rules or algorithms on the one or more non-transitory computer-readable media for future access by the computer during executing of the processing logic.
